(19) United States
(12) Patent Application Publication
(10) Pub. No.: US 2008/0165859 A1
(43) Pub. Date: Jul. 10, 2008

(54) Method of digital video frame buffer compression

(76) Inventors: Chih-Ta Star Sung, Glonn (DE); Yin-Chun Blue Lan, Wurih Township (TW); Wei-Ting Cho, Taichung (TW)

Correspondence Address: Chih-Ta Star Sung, Rm. 308, Bld. 52, No. 195, Sec. 4, Chung Hsin Rd., Juhdong, 310, omitted

(21) Appl. No.: 11/651,126

(22) Filed: Jan. 10, 2007

(51) Int. Cl. H04N 7/26

(52) U.S. Cl. 375/240.24; 375/E07.2

(57) ABSTRACT

The digital video referencing frame image is compressed block by block with each block having a predetermined data rate and each block pixels are divided to be multiple sub-blocks with each sub-block having its divider to code the quotient and remainder of the differential values of adjacent pixel components. A group of blocks pixels share the same referencing pixel component with each block contributes one referencing pixel component and 2 bits to identify the block of most complex pattern falls on. A predetermined data rate is assigned to represent the first pixel component and another predetermined data rate is assigned to represent the first pixel component of a block. An extra amount of bits to represent either the first pixel component or the second and the third pixel components is allowed.

### BACKGROUND OF THE INVENTION

1. Field of Invention

The present invention relates to digital video frame buffer compression, and, more specifically to an efficient video bit stream reference frame buffer compression method that results in the saving of time of accessing the referencing memory and reduction of power consumption.

2. Description of Related Art

ISO and ITU have separately or jointly developed and defined some digital video compression standards including MPEG-1, MPEG-2, MPEG-4, MPEG-7, H.261, H.263 and H.264. The success of development of the video compression standards fuels wide applications which include video telephony, surveillance system, DVD, and digital TV. The advantage of digital image and video compression techniques significantly saves the storage space and transmission time without sacrificing much of the image quality.

Most ISO and ITU motion video compression standards adopt Y, Cb and Cr as the pixel elements, which are derived from the original R (Red), G (Green), and B (Blue) color components. The Y stands for the degree of “Luminance”, while the Cb and Cr represent the color difference been separated from the “Luminance”. In both still and motion picture compression algorithms, the 8×8 pixels “Block” based Y, Cb and Cr goes through the similar compression procedure individually.

There are essentially three types of picture encoding in the MPEG video compression standard. I-frame, the “Intra-coded” picture uses the block of 8×8 pixels within the frame to code itself. P-frame, the “Predictive” frame uses previous I-type or P-type frame as a reference to code the difference. B-frame, the “Bi-directional” interpolated frame uses previous I-frame or P-frame as well as the next I-frame or P-frame as references to code the pixel information. In principle, in the I-frame encoding, all “Block” with 8×8 pixels go through the same compression procedure that is similar to JPEG, the still image compression algorithm including the DCT, quantization and a VLC, the variable length encoding. While, the P-frame and B-frame have to code the difference between a target frame and the reference frames.

In decompressing the P-type or B-type of video frame or block of pixels, accessing the referencing memory requires a lot of time. Due to I/O data pad limitation of most semiconductor memories, accessing the memory and transferring the pixels stored in the memory becomes bottleneck of most implementations. One prior method overcoming the I/O bandwidth problem is to use multiple chips of memory to store the referencing frame which cost linearly goes higher with the amount of memory chip. Some times, higher speed clock rate of data transfer solves the bottleneck of the I/O bandwidth at the cost of higher since the memory with higher accessing speed charges more.

The method and apparatus of this invention significantly speeds up the procedure of reconstructing the digital video frames of pixels without costing more memory chips or increasing the clock rate for accessing the memory chip.

### SUMMARY OF THE INVENTION

The present invention is related to a method of digital video frame buffer compression and decompression which speeds up the procedure of accessing the referencing frame buffer with less power consumption. The present invention reduces the computing times compared to its counterparts in the field of video stream decompression and reaches higher image quality.

The present invention of this efficient video bit stream decompression applies a new decompression method to reduce the data rate of the digital video frame which are used as reference for other non-intra type blocks of image in motion estimation and motion compensation.

The present invention applies the following new concept to achieve low bit rate of storing the reference frame data into a temporary storage device:
Calculation of the differential value of adjacent pixels by applying horizontal and vertical prediction and both direction prediction.
Determining a divider value for the VLC coding of all pixels within a block of Y, luminance, and another divider value for U and V chrominance components.
Coding the quotient and remainder of each pixel component.

According to one embodiment of the present invention, Y luminance and UN chrominance component of each block are compressed separately with separate divider values.

According to one embodiment of the present invention, a predetermined bit rate ratio between the Y and UN is fixed for each block of pixel within a referencing image frame.

According to one embodiment of the present invention, a predetermined length of extra bits is allowed to be allocated from U/V to Y or from Y to U/V and allowing one more clock cycle in accessing the Y or U/V pixel components.

According to another embodiment of the present invention, a block of predetermined amount of pixels is divided into a predetermined amount of sub-blocks“and separate dividers are calculated and assigned to individual sub-block for the VLC coding.

According to another embodiment of the present invention, all sub-blocks or blocks within a group share the same reference sub-pixel component of Y, U and V with the referencing Y, U and V contributed from different sub-block.

According to another embodiment of the present invention, a predetermined length of bits are designed to identify the worst case sub-block or block within a group which does not need to contribute the reference pixel component of Y, U or V.

It is to be understood that both the foregoing general description and the following detailed description are by examples, and are intended to provide further explanation of the invention as claimed.

### BRIEF DESCRIPTION OF THE DRAWINGS

FIG. 1 shows the basic three types of motion video coding.

FIG. 2 depicts a block diagram of a video compression procedure with two referencing frames saved in so named referencing frame buffer.

FIG. 3 illustrates the mechanism of motion estimation.

FIG. 4 illustrates a block diagram of decompressing a video stream.

FIG. 5A depicts the block diagram of an MPEG video encoder with reference memory compression.

FIG. 5B depicts the block diagram of an MPEG video decoder with reference memory compression

FIG. 6 depicts the concept of Y and U/V separately compression with 2 byte of variance of extension from Y to U/V or from U/V to Y.

FIG. 7A depicts the concept of Y and U/V separately compression with separate divider values for Y and U/V.

FIG. 7B depicts the concept of Y and U/V separately compression with one divider value for each sub-block of Y.

FIG. 8 depicts the procedure of the reference frame buffer compression.

FIG. 9A depicts the contribution of the reference pixel within a block with each sub-block contributing one reference Y, U and V component.

FIG. 9B depicts the concept of all sub-blocks sharing the same one referencing pixel component with each sub-block contributing one reference Y, U or V component.

FIG. 10 illustrates the complex patter happened in one of the 4 sub-blocks which takes 2 bits to identify.

### DESCRIPTION OF THE PREFERRED EMBODIMENTS

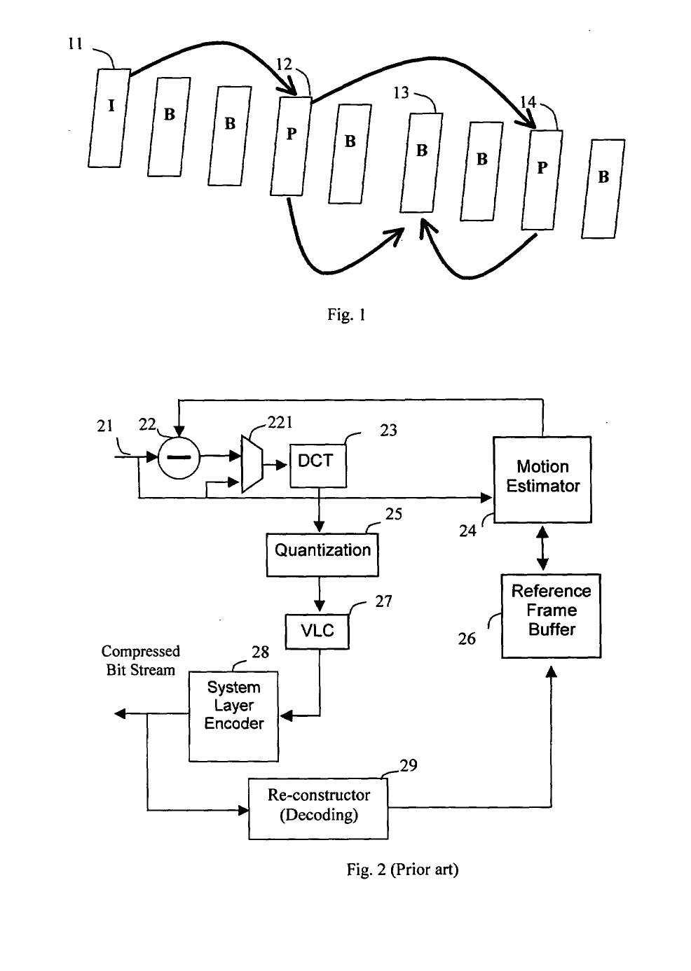

There are essentially three types of picture coding in the MPEG video compression standard as shown in FIG. 1. I-frame 11, the “Intra-coded” picture, uses the block of pixels within the frame to code itself. P-frame 12, the “Predictive” frame, uses previous I-frame or P-frame as a reference to code the differences between frames. B-frame 13, the “Bi-directional” interpolated frame, uses previous I-frame or P-frame 12 as well as the next I-frame or P-frame 14 as references to code the pixel information.

In most applications, since the I-frame does not use any other frame as reference and hence no need of the motion estimation, the image quality is the best of the three types of pictures, and requires least computing power in encoding since no need for motion estimation. The encoding procedure of the I-frame is similar to that of the JPEG picture. Because of the motion estimation needs to be done in referring both previous and/or next frames, encoding B-type frame consumes most computing power compared to I-frame and P-frame. The lower bit rate of B-frame compared to P-frame and I-frame is contributed by the factors including: the averaging block displacement of a B-frame to either previous or next frame is less than that of the P-frame and the quantization step is larger than that in a P-frame. In most video compression standard including MPEG, a B-type frame is not allowed for reference by other frame of picture, so, error in B-frame will not be propagated to other frames and allowing bigger error in B-frame is more common than in P-frame or I-frame. Encoding of the three MPEG pictures becomes tradeoff among performance, bit rate and image quality, the resulting ranking of the three factors of the three types of picture encoding are shown as below:

| | Performance | | |
|---|---|---|---|
| | (Encoding speed) | Bit rate | Image quality |
| I-frame | Fastest | Highest | Best |
| P-frame | Middle | Middle | Middle |
| B-frame | Slowest | Lowest | Worst |

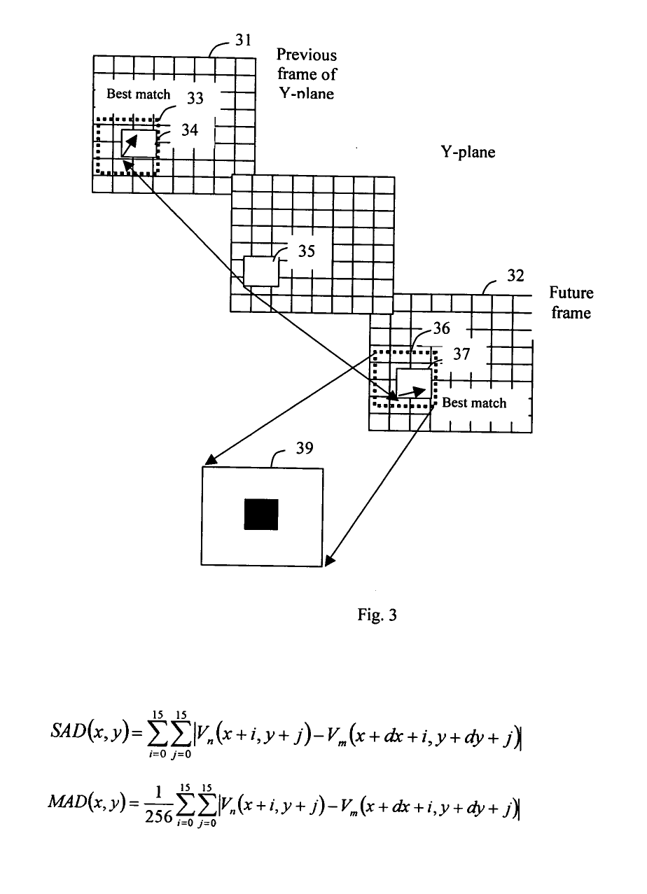

FIG. 2 shows the block diagram of the MPEG video compression procedure, which is most commonly adopted by video compression IC and system suppliers. In I-type frame coding, the MUX 221 selects the coming original pixels 21 to directly go to the DCT 23 block, the Discrete Cosine Transform before the Quantization 25 step. The quantized DCT coefficients are packed as pairs of “Run-Length” code, which has patterns that will later be counted and be assigned code with variable length by the VLC encoder 27. The Variable Length Coding depends on the pattern occurrence. The compressed I-type frame or P-type bit stream will then be reconstructed by the reverse route of decompression procedure 29 and be stored in a reference frame buffer 26 as future frames' reference. In the case of compressing a P-frame, B-frame or a P-type, or a B-type macro block, the macro block pixels are sent to the motion estimator 24 to compare with pixels within macroblock of previous frame for the searching of the best match macroblock. The Predictor 22 calculates the pixel differences between the targeted 8×8 block and the block within the best match macroblock of previous frame or next frame. The block difference is then fed into the DCT 23, quantization 25, and VLC 27 coding, which is the same procedure like the I-frame coding.

In the encoding of the differences between frames, the first step is to find the difference of the targeted frame, followed by the coding of the difference. For some considerations including accuracy, performance, and coding efficiency, in some video compression standards, a frame is partitioned into macroblocks of 16×16 pixels to estimate the block difference and the block movement. Each macroblock within a frame has to find the “best match” macroblock in the previous frame or in the next frame. The mechanism of identifying the best match macroblock is called “Motion Estimation”.

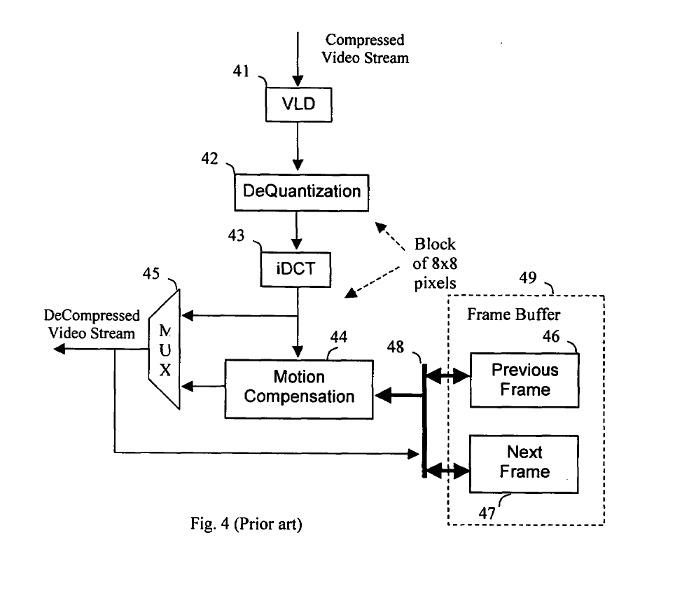

Practically, a block of pixels will not move too far away from the original position in a previous frame, therefore, searching for the best match block within an unlimited range of region is very time consuming and unnecessary. A limited searching range is commonly defined to limit the computing times in the “best match” block searching. The computing power hungered motion estimation is adopted to search for the “Best Match” candidates within a searching range for each macro block as described in FIG. 3. According to the MPEG standard, a “macro block” is composed of four 8×8 “blocks” of “Luma (Y)” and one, two, or four “Chroma (2 Cb and 2 Cr)”. Since Luma and Chroma are closely associated, in the motion estimation, only Luma motion estimation is needed, and the Chroma, Cb and Cr in the corresponding position copy the same MV of Luma. The Motion Vector, MV, represents the direction and displacement of the block movement. For example, an MV=(5, −3) stands for the block movement of 5 pixels right in X-axis and 3 pixels down in the Y-axis. Motion estimator searches for the best match macroblock within a predetermined searching range 33, 36. By comparing the mean absolute differences, MAD or sum of absolute differences, SAD, the macroblock with the least MAD or SAD is identified as the “best match” macroblock. Once the best match blocks are identified, the MV between the targeted block 35 and the best match blocks 34, 37 can be calculated and the differences between each block within a macro block are encoded accordingly. This kind of block difference coding technique is called “Motion Compensation”.

The Best Match Algorithm, BMA, is the most commonly used motion estimation algorithm in the popular video compression standards like MPEG and H.26x. In most video compression systems, motion estimation consumes high computing power ranging from ˜50% to ˜80% of the total computing power for the video compression. In the search for the best match macroblock, a searching range, for example ±16 pixels in both X- and Y-axis, is most commonly defined. The mean absolute difference, MAD or sum of absolute difference, SAD as shown below, is calculated for each position of a macroblock within the predetermined searching range, for example, a ±16 pixels of the X-axis

$$SAD ( x , y ) = {\sum }_{i = 0}^{15} {\sum }_{j = 0}^{15} \vert {V}_{n} ( x + i , y + j ) - {V}_{m} ( x + dx + i , y + dy + j ) \vert$$

$$MAD ( x , y ) = \frac{1}{256} {\sum }_{i = 0}^{15} {\sum }_{j = 0}^{15} \vert {V}_{n} ( x + i , y + j ) - {V}_{m} ( x + dx + i , y + dy + j ) \vert$$

and Y-axis. In above MAD and SAD equations, the Vn and Vm stand for the 16×16 pixel array, i and j stand for the 16 pixels of the X-axis and Y-axis separately, while the dx and dy are the change of position of the macroblock. The macroblock with the least MAD (or SAD) is from the BMA definition named the “Best match” macroblock. The calculation of the motion estimation consumes most computing power in most video compression systems.

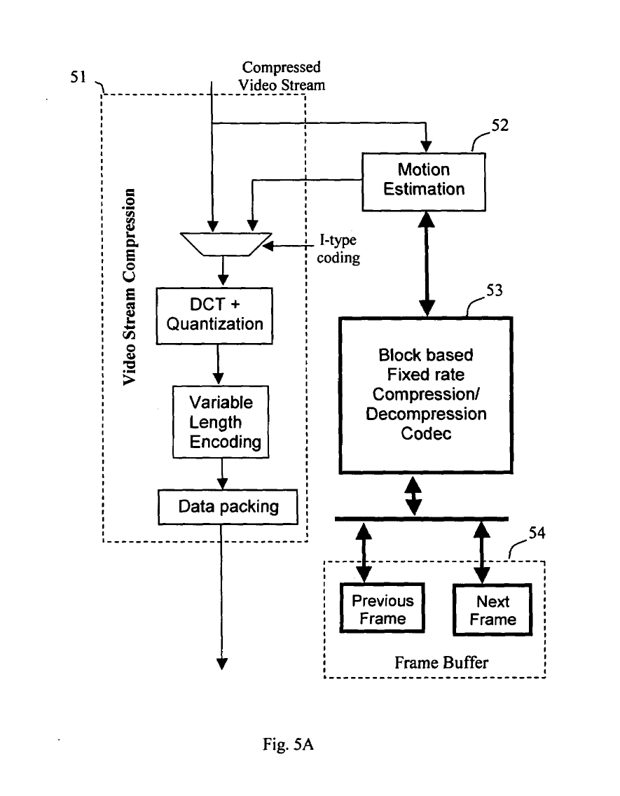

FIG. 4 illustrates the procedure of the MPEG video decompression. The compressed video stream with system header having many system level information including resolution, frame rate, . . . etc. is decoded by the system decoder and sent to the VLD 41, the variable length decoder. The decoded block of DCT coefficients is shifted by the “Dequantization” 42 before they go through the iDCT 43, inverse DCT, and recovers time domain pixel information. In decoding the non intra-frame, including P-type and B-type frames, the output of the iDCT are the pixel difference between the current frame and the referencing frame and should go through motion compensation 44 to recover to be the original pixels. The decoded I-frame or P-frame can be temporarily saved in the frame buffer 49 comprising the previous frame 46 and the next frame 47 to be reference of the next P-type or B-type frame. When decompressing the next P-type frame or next B-type frame, the memory controller will access the frame buffer and transfer some blocks of pixels of previous frame and/or next frame to the current frame for motion compensation. Transferring block pixels to and from the frame buffer consumes a lot of time and I/O bandwidth of the memory or other storage device. To reduce the required density of the temporary storage device and to speed up the accessing time in both video compression and decompression, compressing the referencing frame image is an option and a new approach.

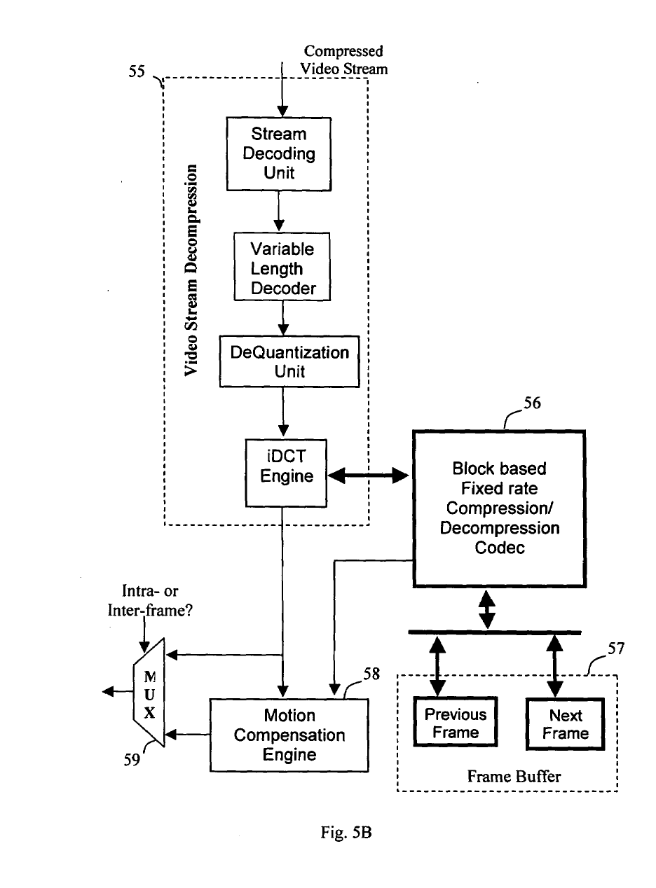

FIG. 5A shows the video compression mechanism with the referencing frame buffer compression. The basic video compression procedure 51 includes DCT, quantization, a VLC coding and the final data packing. In the mode of non-intra coding, the coming picture are compared to previous and/or next frame for coding the difference which is called “motion estimation” 52. The reference block pixels of previous frame and/or the next frame are compressed before saving into the frame buffer 54. For making the frame buffer accessing easier, each block of pixels are compressed with a predetermined data rate 53. While, FIG. 5B shows the video decompression mechanism with the referencing frame buffer compression. The basic video decompression procedure 55 includes a video stream decoding unit, a VLC decoding unit, a de-quantization, and an inverse DCT. In the mode of non-intra decoding, the reference block pixels of previous frame and/or the next frame are compressed 56 with a predetermined data rate of each block before saving into the frame buffer 57.

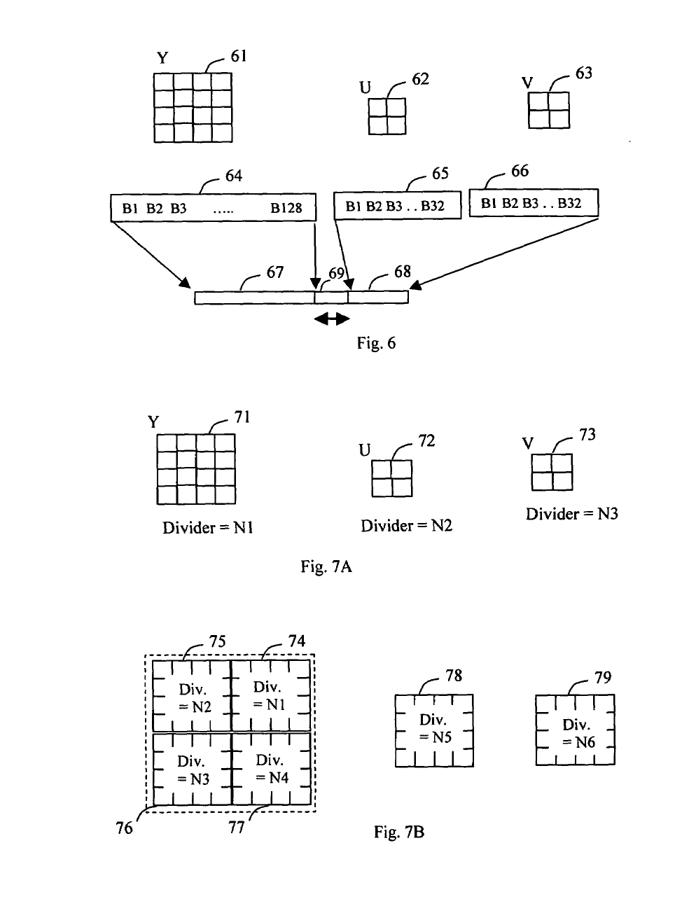

To ease the access of the referencing memory, each block of pixels of the reference frame is compressed with a fixed predetermined data rate, for example 2.0× times. The block size is also predetermined. FIG. 6 shows an example of a block of 4×4 pixel of Y, luminance components 61 and a 2×2 U components 62 and another 2×2 V components 63. The U and V are named chrominance. The original bit rate of the 4×4 Y components 64 is 128 bits and the U components 65 have 32 bits and V components 66 are comprised of another 32 bits. The Y is compressed independently on the U/V with a predetermined bit rate 67. And the U and V are compressed together as a unit of chrominance with another predetermined bit rate 68. In some cases, the Y components have complex pattern and a predetermined amount of bits, for example, an extra 16 bits are given to code the Y components. Same to Y component, when the complexity happens to U and/or V components, an allowance of an extra 16 bits can be allocated to represent U/V components. This variance allowance 69 of a predetermined bit gives flexibility of bit allocation and enhances the quality of image of the fixed block pixels of the reference frame image. In decompressing the compressed block pixels, the variance of extra bits of Y or U/V will be firstly recovered and the rest bits of a fixed rate within a block is decoded as another pixel components. Blocks of compressed Y luminance components are saved into the temporary storage device with continuous address starting from a predetermined location, while blocks of compressed U/V chrominance components are saved into the temporary storage device with continuous address starting from another predetermined location.

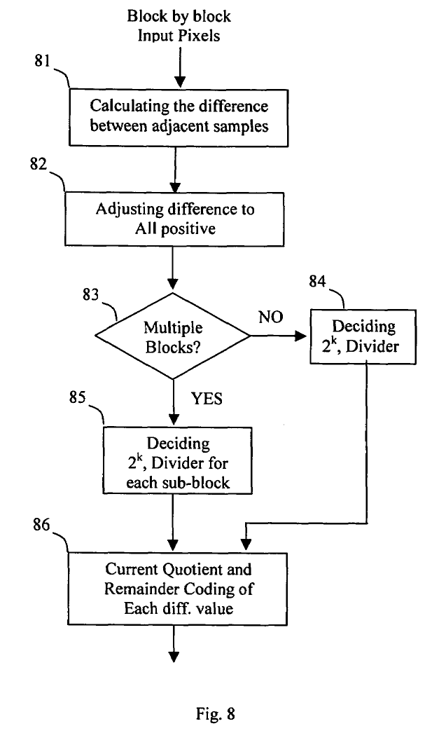

FIG. 7A illustrates a mechanism of a VLC coding of the differential values between adjacent pixel components of Y 71, U 72 and V 73 within a block with the same amount of pixels in x-axis and y-axis. For quick recovering in decompression, one block of each pixel component, Y, U and V uses its corresponding divider, said N1 for Y, N2 for U and N3 for V component. FIG. 7B illustrates this coding method for a block comprising multiple sub-blocks case. Each sub-block 74, 75, 76, 77 is assigned a corresponding divider value, said N1, N2, N3 and N4 and the remainder and quotient are calculated and coded accordingly. The dividers 78, 79 of the color components are calculated and determined separately. To obtain the best compression rate or better image quality with a predetermined data rate, a larger divider value is assigned to represent the divider of the block with complex patterns while a small divider value is assigned to represent the divider for the block with simple patterns.

All pixels within the same sub-block share the same divider value accelerates the speed of encoding the pixels since there is no need for waiting the generation of divider for each pixel. And the divider value is an optimized value for the worst case pattern within the corresponding sub-block. In the sub-block with complex pattern, the divider value will be set high since the differential values of adjacent pixels are in average higher and results resulting in shorter code in representing the quotient.

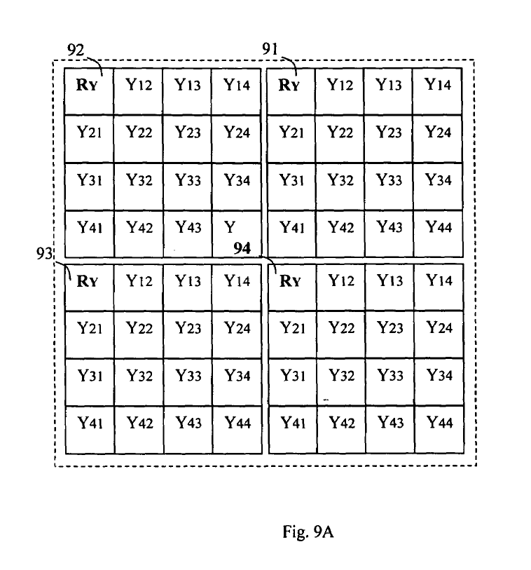

FIG. 8 illustrates the procedure chart of encoding the block pixels. Pixels are input block by block into the compression engine firstly. The differential values between adjacent pixels within a block or a sub-block are calculated 81. The differential values might be positive or negative. The 2^{nd} procedure is to shift the negative differential value to be positive 82. If the block is a small size, it could be a single block 83 and a single divider is calculated and assigned 84 to code that small block of pixels. If the block includes multiple sub-blocks, the divider of each sub-block 85 is calculated to code the quotient and remainder 86 of each pixels within the corresponding sub-block. Partitioning a block of pixels into multiple sub-blocks depends on the block size. The larger the block size, the higher chance of need to divide the block to be multiple sub-blocks to reach a good compression rate or image quality.

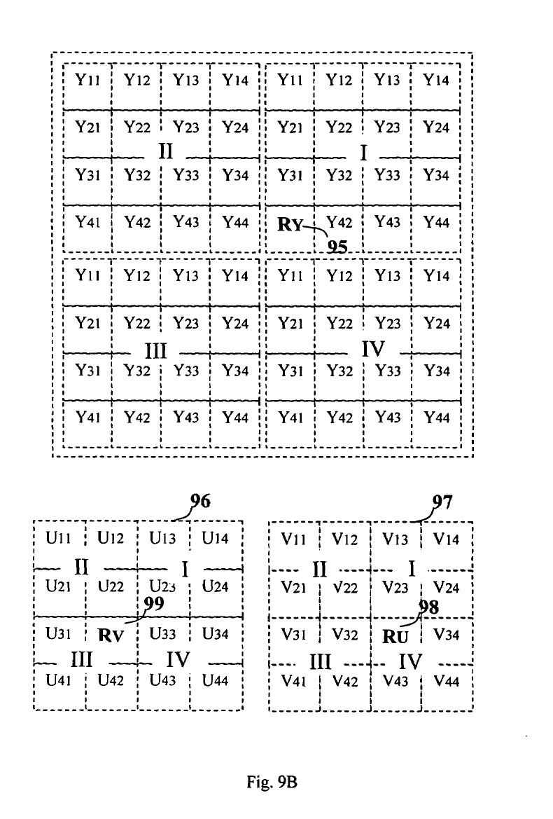

In this invention of coding a block of pixels, each block or sub-block of pixels needs one pixel component as the referencing pixel as the starting pixel and other pixels just calculate the differential value between adjacent pixels with the predetermined order. FIG. 9A illustrates 4 sub-blocks of Y, the luminance components with each sub-block having a referencing pixel 91, 92, 93, 94. Another method that further reduces the data rate is to let all sub-blocks within a block share the same reference pixel component as shown in FIG. 9B as an example. The sub-block of the first quadrant within a block contributes one pixel component, Y, the luminance component as the reference 95 for all 4 sub-blocks for the. The sub-block of the forth quadrant within a block contributes one pixel component, U, the chrominance component as the reference 98 of all 4 sub-blocks of U chrominance components 97. The sub-block of the third quadrant within a block contributes one pixel component, V, the chrominance component as the reference 99 of all 4 sub-blocks of V chrominance components 96. For reducing the time of coding, the referencing pixel component is selected to be the pixel within shortest distance to all other blocks' starting pixels, for example, the corner of left bottom of the first quadrant block. All sub-blocks shares one referencing pixel component, Y, U or V represents a saving of 8 bits in sub-blocks those don't contribute the referencing pixel component which helps in increasing the image quality under a predetermined data rate. The pixel component of Y, luminance or U/V chrominance can also be replaced by Red, Green and/or Blue color component and apply this method of using one referencing pixel component to be shared with multiple blocks or sub-blocks.

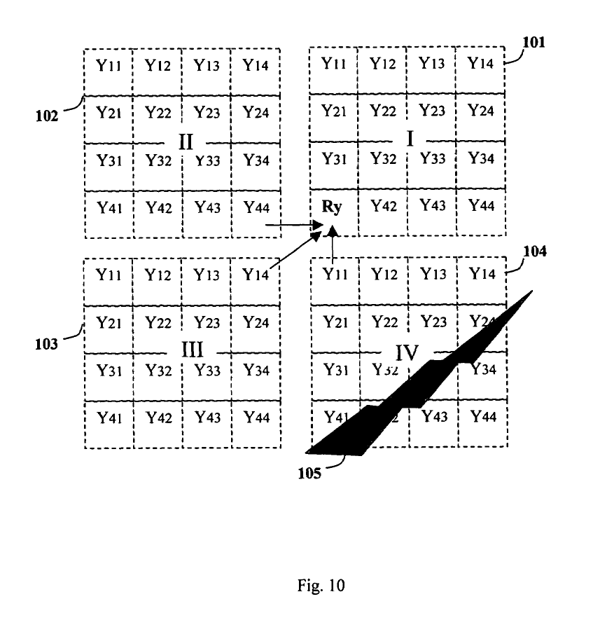

Since most imaging systems use 3 color components to represent a pixel, R, G, B or Y, U and V, there will be one sub-block within a block does not need to contribute the referencing pixel component. For further enhancing the image quality, a predetermined bit number, said 2 bits in a block with 4 quadrants (sub-blocks) are assigned to identify the location of the sub-block which has most complex pattern and will need more bits to represent the pixels in compression. As shown in FIG. 10 an object, for example, an edge 105 of object shows up in the fourth quadrant 104, 2 bits are reserved to represent the fourth quadrant having complex pattern which sub-block does not need to contribute any referencing pixel component hence leaving more bits to represent the compressed pixels.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of reducing the bit rate of the reference frame in digital video compression and decompression, comprising:
partitioning a block of pixels into a predetermined amount of sub-blocks with each sub-block having a predetermined amount of pixel components;
calculating and deciding the bit length representing the pixels within each sub-block with which the predetermined lossless coding algorithm can be feasibly applied to reach the goal of lossless compression;
calculating the differential values of adjacent pixels within a sub-block;
determining an appropriate divider value for all pixel components within each sub-block; and
coding the quotients and remainders of the differential values of the differential values of pixel components of each sub-block within a block.

2. The method of claim 1, wherein the length of pixel is fixed for all pixels within a block or a sub-block and is determined by keeping the original pixel component or by truncating the LSB bits.

3. The method of claim 2, wherein should truncating LSB bits is needed, the number of bits to be truncated is firstly calculated by examining whether the truncation can meet lossless quality.

4. The method of claim 1, wherein the divider value of a block or a sub-block is determined by applying multiple dividers to code the block or sub-block pixel components and the one resulting in the shortest code is selected to be the divider for coding the pixels of the corresponding block or sub-block.

5. The method of claim 1, wherein a block of pixels are comprised of a predetermined amount of pixels with the same amount of pixels in x-axis and y-axis.

6. The method of claim 1, wherein a block of pixels are comprised of a predetermined amount of pixels comprised of another predetermined amount of Y luminance components, U chrominance component and V chrominance components.

7. The method of claim 1, wherein a larger value is assigned to represent the divider value for the block or sub-block with more complex pattern and a smaller value is assigned to represent the divider for the block or sub-block with simple pattern.

8. A method of compressing a group of blocks of pixels within a referencing frame buffer, comprising:
selecting one of the first pixel components from the first block within a group of blocks to be the reference and calculating the differential values of adjacent pixels components of at least two blocks within the same group of blocks of pixels;
selecting one of the second pixel components from the second block within a group of blocks to be the reference and calculating the differential values of adjacent pixels components of at least two blocks within the same group of blocks of pixels;
selecting one of the third pixel components from the third block within a group of blocks to be the reference and calculating the differential values of adjacent pixels components of at least two blocks within the same group of blocks of pixels;
determining an appropriate divider value for each block or sub-block of pixel components within the group of blocks; and
coding the quotients and remainders of the differential values of each block pixel component within a group of blocks or sub-blocks.

9. The method of claim 8, wherein a group of pixel components are Y, luminance or U chrominance or V chrominance components which at least two blocks share the same referencing pixel component in coding the differential values.

10. The method of claim 8, wherein a group of pixel components are Red, Green or Blue color component which at least two blocks share the same referencing pixel color component in coding the differential values.

11. The method of claim 8, wherein the selected referencing pixel component is within the shortest distance to other blocks' starting pixels within the same group of blocks.

12. The method of claim 8, wherein at least two bits are reserved to identify the block with the most complex pattern within a group of blocks.

13. A method of compressing a block of pixels with predetermined amount of pixels, comprising:
compressing the first pixel components within a block or a sub-block with a predetermined fixed bit rate;
compressing the second and third pixel components within a block or a sub-block with another predetermined fixed bit rate; and
allowing a predetermined amount of extra bits to be allocated from U/V pixel components within a block to code the Y pixel components or from Y pixel components to code the U/V pixel components.

14. The method of claim 13, wherein the compression rate of the first pixel component, Y luminance is preset to be lower than that of the U and V chrominance component.

15. The method of claim 13, wherein the second and third pixel components are compressed separately but clustered together as a chrominance compression unit with a predetermined fixed data rate.

16. The method of claim 13, wherein should the complex pattern happened in either Y, luminance components or U/V chrominance components, at least extra eight bits are allowed to be allocated from U/V components to code the Y components or from Y components to code the U/V components should complex patter happened in the U/V chrominance components.

17. The method of claim 13, wherein at least two continuous blocks of the compressed Y luminance components are saved in to the storage device with continuous location and at least two continuous blocks of U/V chrominance components are saved to the storage device with another continuous location.

18. The method of claim 13, wherein the compressed blocks of Y luminance components are continuously saved in different starting location from the compressed blocks of U/V chrominance components.
